(19) United States
(12) Patent Application Publication
(10) Pub. No.: US 2003/0013001 A1
(43) Pub. Date: Jan. 16, 2003

(54) Carrier gasket for a fuel cell

(76) Inventors: Steve George Koch, Gregory, MI (US); Mark Allen Belchuk, Windsor (CA)

Correspondence Address: FREUDENBERG-NOK G.P., 47690 E. ANCHOR CT., PLYMOUTH, MI, 48170, US

(21) Appl. No.: 10/113,832

(22) Filed: Mar. 30, 2002

Related U.S. Application Data
(60) Provisional application No. 60/280,272, filed on Mar. 30, 2001.

(51) Int. Cl. H01M 8/02; H01M 2/08

(52) U.S. Cl. 429/35; 429/36

(57) ABSTRACT

The present invention includes a fuel cell assembly. The fuel cell gasket preferably includes a gasket assembly, wherein the gasket assembly includes thin, flexible carrier having a first surface and a second surface. An elastomeric seal is molded onto the first surface of the carrier. Additionally, a second elastomeric seal is preferably molded onto the second surface of the carrier. Additionally, a pressure sensitive adhesive is preferably applied to the second surface of the carrier.

### CROSS REFERENCE TO RELATED APPLICATION

This claims the benefit of United States provisional patent application identified as Application No. 60/280,272, filed Mar. 30, 2001.

### BACKGROUND OF THE INVENTION

This invention relates in general to fluid seals. More specifically, this invention relates to static gaskets for various encapsulating covers and especially fuel cells.

A fuel cell is an electromechanical energy converter consisting of two electrodes that are placed on opposite surfaces of an electrolyte. In one form, an ion-conducting polymer electrolyte membrane is disposed between two electrode layers to form a membrane electrode assembly (MEA). The MEA is typically porous and electrically conductive to promote the desired electrochemical reaction from two reactants. One reactant, oxygen or air, passes over one electrode, while hydrogen, the other reactant, passes over the other electrode to produce electricity, water, and heat.

An individual cell includes an MEA placed between a pair of separator plates. The separator plates are typically fluid impermeable and electrically conductive. Fluid flow passages or channels are formed on each plate surface adjacent to the electrode layer to facilitate access of the reactants to the electrodes and the removal of the products of the chemical reaction. In such fuel cells, resilient gaskets or seals are typically provided streams.

### BRIEF SUMMARY OF THE INVENTION

The present invention includes a fuel cell assembly. The fuel cell gasket preferably includes a gasket assembly, wherein the gasket assembly includes thin, flexible carrier having a first surface and a second surface. An elastomeric seal is molded onto the first surface of the carrier.

Additionally, a second elastomeric seal is preferably molded onto the second surface of the carrier.

Additionally, a pressure sensitive adhesive is preferably applied to the second surface of the carrier.

### BRIEF DESCRIPTION OF THE DRAWINGS

FIG. 1 is an exploded view of a fuel cell assembly according to this invention.

FIG. 2 is a sectional view taken of a first embodiment of a carrier gasket of the fuel cell assembly of FIG. 1.

FIG. 3 is a sectional view of a second embodiment of a carrier gasket that can be used in the fuel cell assembly of FIG. 1.

FIG. 4 is a sectional view of a third embodiment of a carrier gasket that can be used in the fuel cell assembly of FIG. 1.

### DETAILED DESCRIPTION OF THE PREFERRED EMBODIMENTS

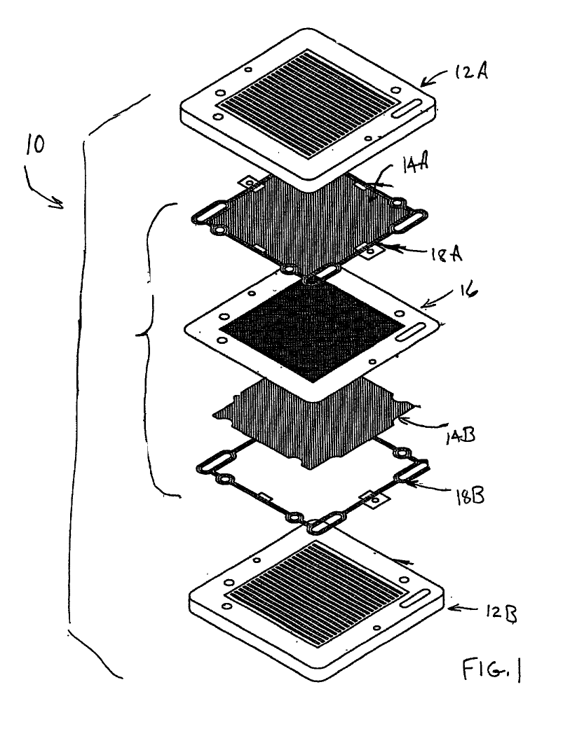

A fuel cell assembly is indicated generally at 10 in FIG. 1. The fuel cell assembly 10 includes a first flow field plate 12A and a second flow field plate 12B, a first gas diffusion layer (GDL) 14A and a second gas diffusion layer 14B, and an ion exchange polymer membrane 16 having a catalyst. The catalyst is sometimes mounted on the GDL. Two static gasket assemblies 18A and 18B are used to seal the fuel cell 10.

A first embodiment of a gasket assembly according to this invention is indicated generally at 100 in FIG. 2. The gasket assembly 100 can be used for either of the gasket assemblies 18A and/or 18B of the fuel cell assembly 10 of FIG. 1. The gasket assembly 100 includes a thin, flexible carrier 102 that has a preferred thickness of less than 1.0 mm and is preferably made from a polymeric material. The flexible carrier 102 has a first surface 104 and a second surface 106. An elastomeric seal 108 is molded to one of the surfaces of the carrier 102, e.g., surface 104 as shown in FIG. 2. A layer of pressure sensitive adhesive 110 is applied to the opposite surface 104 of the carrier 102. Preferably, a bead 112 projects from the seal 108.

When the gasket assembly 100 is utilized in the fuel cell 10, the bead 112 is in sealing contact with a flow field plate 12A or 12B. The pressure sensitive adhesive 110 holds the gasket assembly 100 to the ion exchange polymer membrane 16 and forms a seal between the gasket assembly 100 and the ion exchange polymer member 16.

The carrier 102, although flexible, aids in handling the seal 108. The carrier 102 improves the retention of two (X-Y) dimensions of the seal 108 than the seal 108 would otherwise have without the carrier 102.

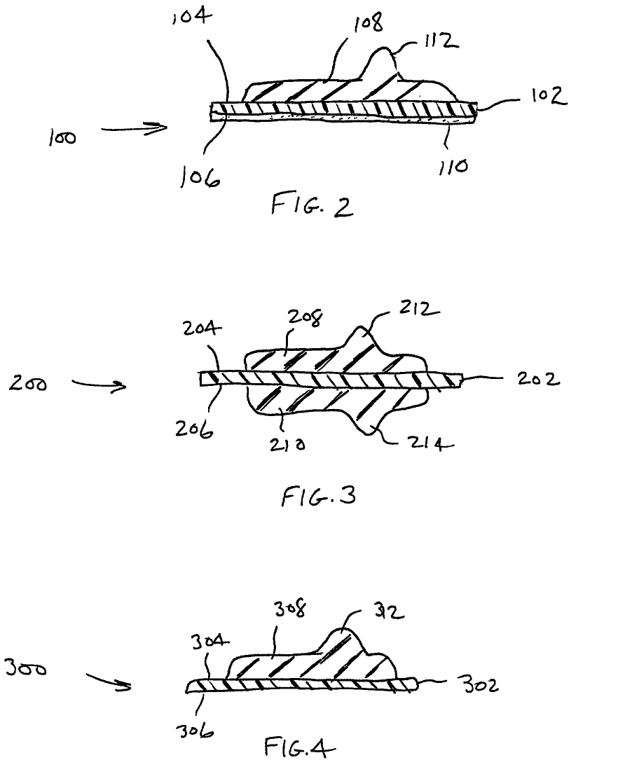

A second embodiment of a gasket assembly 200 according to this invention is indicated generally at 200 in FIG. 3. The gasket assembly 200 can be used for either of the gasket assemblies 18A and/or 18B of the fuel cell assembly 10 of FIG. 1. The gasket assembly 200 includes a thin, flexible carrier 202 that has a preferred thickness of less than 1.0 mm and is preferably made from a polymeric material. The flexible carrier 202 has a first surface 204 and a second surface 206. A first elastomeric seal 208 is molded to surface 202 of the carrier 202. A second elastomeric seal 210 is molded to surface 204 of the carrier 202. Preferably, a bead 212 projects from seal 208. Preferably a bead 214 projects from seal 210.

When the gasket assembly 200 is utilized in the fuel cell 10, the bead 212 is in sealing contact with a flow field plate 12A or 12B. The bead 214 is in sealing contact with the ion exchange polymer membrane 16

A third embodiment of a gasket assembly according to this invention is indicated generally at 300 in FIG. 4. The gasket assembly 300 can be used for either of the gasket assemblies 18A and/or 18B of the fuel cell assembly 10 of FIG. 1. The gasket assembly 300 includes a thin, flexible carrier 302 that has a preferred thickness of less than 1.0 mm and is preferably made from a polymeric material. The flexible carrier 302 has a first surface 304 and a second surface 306. An elastomeric seal 308 is molded to surface 304 of the carrier 302. Preferably, a bead 312 projects from seal 308.

When the gasket assembly 300 is utilized in the fuel cell 10, the bead 312 is in sealing contact with a flow field plate 12A or 12B.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A fuel cell assembly including a gasket assembly, wherein the gasket assembly includes thin, flexible carrier having a first surface and a second surface, wherein an elastomeric seal is molded onto the first surface of the carrier.

2. The fuel cell assembly specified in claim 1 wherein a second elastomeric seal is molded onto the second surface of the carrier.

3. The fuel cell assembly specified in claim 1 wherein a pressure sensitive adhesive is applied to the second surface of the carrier.
